(19) United States
(12) Patent Application Publication
(10) Pub. No.: US 2006/0165835 A1
(43) Pub. Date: Jul. 27, 2006

(54) Extrusion die having at least flexible lip element

(76) Inventors: Gerhard Vegelbacher, Singen (DE); Hubertus Barthel, Volkertshausen (DE); Thinh Van Pham, Konztanz (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 10/561,736

(22) PCT Filed: Mar. 18, 2004
(86) PCT No.: PCT/EP04/02782

§ 371 Date: Dec. 20, 2005

(30) Foreign Application Priority Data
Jun. 20, 2003 (DE) 103 28 104.5

(51) Int. Cl. B29C 47/12

(52) U.S. Cl. 425/380; 425/465

(57) ABSTRACT

The invention relates to an extrusion die having at least one flexible lip element (1, 2) for discharging extruded material from a gap (S) the flow cross-section of which can be modified. The invention is characterized in that at least one flexible lip element (2) can be displaced relative to the other lip element (1) by means of a plurality of jointly actuated lever elements (8).

The present invention relates to an extrusion die having at least one flexible lip element for discharging extruded material from a gap, the flow cross section of which can be modified.

Conventional extrusion dies are known and available on the market in various forms and designs. Reference is made to U.S. Pat. No. 5,494,429, for example, which describes an extrusion die for extruding thermoplastic materials.

An extrusion die having at least one flexible lip element is also known from EP 0 668 143 A1, in which a flexural bar is moved via an eccentric motion relative to an oblique surface of the die body to modify an exit region of the lip element.

A disadvantage herein is that great force is necessary to move the flexural bar relative to the die body, in particular as the result of high friction.

Bending, or such a flexural bar and the eccentric motion thereof, is also subject to play, which is undesired.

The object of the present invention, therefore, is to provide an extrusion die of the aforementioned type which eliminates the referenced disadvantages, and by which a gap height, i.e., a gap of an extrusion die composed of two lip elements, may be modified in a simple and economical manner.

The invention provides for a homogeneous modification of a gap height over an entire width. In addition, the invention provides that small actuating forces for flexible movement of the lip element are necessary for modifying a gap height. Furthermore, according to the invention, assembly and maintenance costs as well as manufacturing costs for actuating elements are significantly reduced.

This object is achieved in that at least one flexible lip element can be moved relative to the other lip element by means of a plurality of jointly actuatable lever elements.

It has been shown to be particularly advantageous in the present invention to provide a plurality of lever elements over an entire width between an exit region and a die body, and a flexural area therebetween, the lever elements being pivotably mounted in the exit region of the die body. In the oppositely situated die body the lever elements, which are situated in parallel, are likewise mounted in an articulated manner in a slide which is mounted and supported in a recess in the die body or a separate retaining element.

For a configuration having a small angle, depending on the actuation of the slide element the exit region may be bent with respect to the die body by means of the actuating lever, so that the gap height for the oppositely situated lip element may be made smaller or larger.

In this manner allowance may be made for different thicknesses of films or sheets to be produced, so that the same extrusion die may be used to produce a variety of different products of different thicknesses. Conversion is greatly simplified, since in order to modify the gap height the slide need only be moved with respect to the base body or a retaining element, using corresponding actuating elements, to actuate the lever elements. This feature also lies within the scope of the present invention.

Further advantages, features, and particulars of the invention result from the following description of preferred exemplary embodiments, and with reference to the drawings, which show the following:

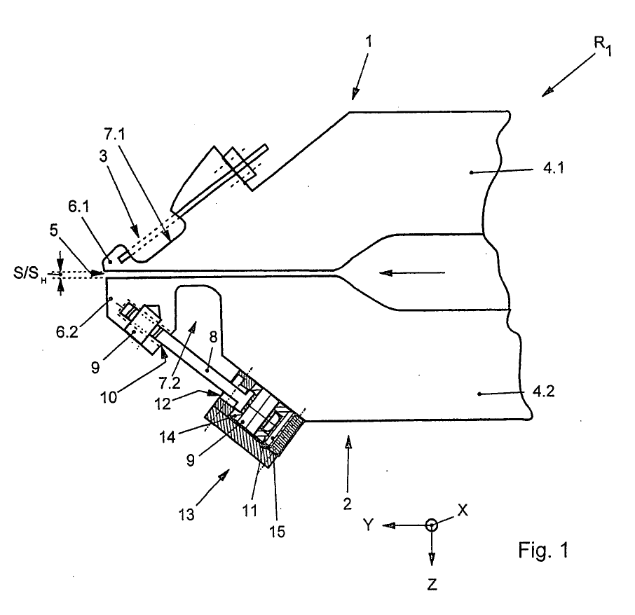

FIG. 1 shows a schematically illustrated, at least partially cutout side view of an extrusion die having two flexible lip elements;

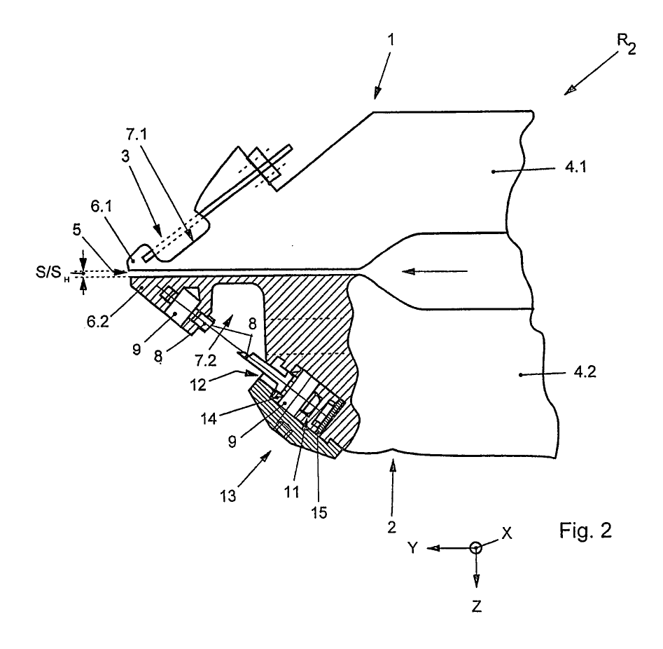

FIG. 2 shows a schematically illustrated at least partially cutout side view of a further exemplary embodiment of another extrusion die according to FIG. 1;

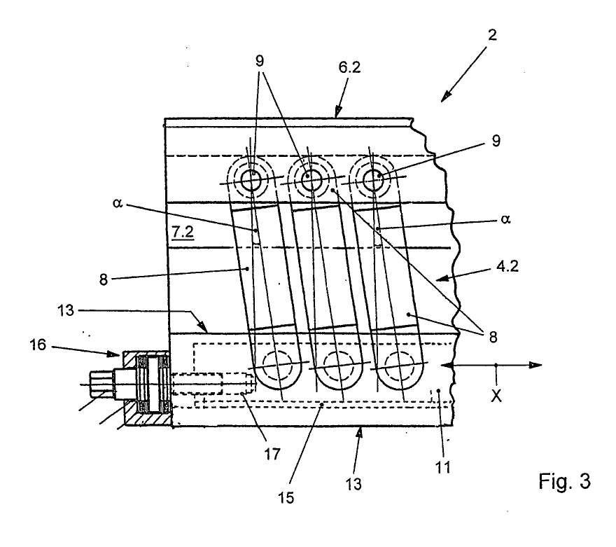

FIG. 3 shows a schematically illustrated top view of one section of a flexible lip element, in particular in the region of the lever elements according to the invention; and

FIG. 4 shows a schematically illustrated cross-sectional view of a flexible lip element, in particular in the region of the lever elements according to the invention and the slide.

According to FIG. 1, an extrusion die R₁ according to the invention has a first, upper flexible lip element 1 which cooperates with a second, lower flexible lip element 2, and between the two lip elements 1, 2 a gap S is formed which runs over the entire width.

To compensate for or to adjust the flow cross section of the lip element 1 over its entire width (not illustrated here in greater detail), a plurality of adjacently positioned actuators 3 are associated with the upper flexible lip element 1 which allow manual fine adjustment, in particular compensation, of the flexible lip element 1 over the corresponding location and over the entire width.

The lip element 1 is formed essentially from a die body 4.1, an exit region 6.1 being formed in one region of a gap opening 5, and a tapered flexural region 7.1 being formed between the die body 4.1 and the exit region 6.1, preferably in the vicinity of or near the gap opening 5.

To form a parallel flow cross section, a second flexible lip element 2 according to the invention is oppositely situated, the lip element likewise having a die body 4.2, and an exit region 6.2 being formed near the gap opening 5. A tapered flexural region 7.2 is provided between the exit region 6.2 and the die body 4.

According to the present invention, the flexible lip element 2 is provided with a plurality of jointly actuatable lever elements 8 which in particular span the flexural region 7.2.

The lever elements 8, which are separated at a slight distance from one another, are mounted in the exit region 6.1 over the entire width by bolts 9 (only indicated here), and on one end the lever elements 8 engage in a groove 10.

On the other end, the lever elements 8, as shown for example in FIGS. 3 and 4, engage in a slide 11, and are mounted there so as to be pivotable about an angle α (see FIG. 3) in recesses 12 (only indicated here) in the slide 11.

The slide 11 is linearly mounted in a retaining element 13 (see FIG. 1) so as to be movable back and forth in an illustrated X direction with respect to the retaining element 13.

The retaining element 13 may be detachably fixed to the die body 4.2, as indicated in FIG. 1. However, as shown in particular in the exemplary embodiment of an extrusion die R₂ according to FIG. 2, the retaining element 13 may also be integrated into the die body 4.2, a corresponding recess 12 being provided in the die body 4.2 for accommodating the slide 11 in which the lever elements 8 are mounted. The slide 11 is supported or mounted in the retaining element 13, in the direction of pushing or pulling of the lever elements 8, by corresponding bearing elements 14, 15 (only indicated here). Needle roller bearings or the like are preferably used as bearing elements 14, 15.

To move the slide 11 back and forth in the illustrated X direction about the lever elements 8, which preferably are situated at a close distance to one another over the entire width of the lip element 2, an actuating element 16 which in the preferred exemplary embodiment is designed as a threaded spindle is associated with the die body 4.2. Corresponding radial rotation of an adjusting spindle 17 moves the slide 11 back and forth in the X direction.

The adjusting spindle 17, i.e., the actuating element 16, may be provided with any given driven device, it being within the scope of the present invention to use appropriate hydraulic cylinders, servomotors, appropriate gearing, or the like to allow the slide to move back and forth in the illustrated X direction.

An advantage of the present invention is that the back-and-forth motion of the slide 11, which preferably is precisely and accurately supported in the retaining element 13 by the bearing elements 14, 15, allows a gap S in lip element 2 to be modified with respect to lip element 1, in particular for an angular setting of the lever elements 8.

This modification may be performed automatically or manually, in particular the exit region 6.2 then being bent with respect to the die body 4.2 by means of the tapered flexural region 7.2.

A homogeneous, exact adjustment of the gap S to achieve a different, selectable gap height S_{H} is possible for the plurality of adjacently positioned lever elements 8, over the entire width of the extrusion die.

In particular, very high bending forces for deforming the exit region 6.2 of the lip element 2 over the entire width of the lip element 2 may be achieved by the plurality of lever elements 8. In addition, the forces for the actuating element 16 are reduced by the corresponding lever configuration of the lever elements 8 and the optimal bearing of the slide 11 to ensure an exact, precise adjustment, in particular, bending of the exit region 6.2 of the lip element 2.

The exit region 6.2 may thus be exactly and precisely modified with respect to the exit region 6.1 over the entire width in order to set a gap height S_{H} for a desired flow cross section. In this manner, one die may be used to produce films and/or sheets of different thicknesses, it being possible to adjust the gap S very quickly only by use of the manually or automatically controllable actuating element 16 without having to interrupt production.

It is even conceivable to modify or adjust the gap width during the manufacturing process, or to convert operations for the manufacture of another product. This feature is likewise within the scope of the present invention.

### List of Reference Numbers

| | |
|---|---|
| 1 | Lip element |
| 2 | Lip element |
| 3 | Actuator |
| 4 | Die body |
| 5 | Gap opening |
| 6 | Exit region |
| 7 | Flexural region |
| 8 | Lever element |
| 9 | Bolt |
| 10 | Groove |
| 11 | Slide |
| 12 | Recess |
| 13 | Retaining element |
| 14 | Bearing element |
| 15 | Bearing element |
| 16 | Actuating element |
| 17 | Adjusting spindle |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| R1 | Extrusion die |
| R2 | Extrusion die |
| S | Gap |
| SH | Gap height |

1. An extrusion die having at least one flexible lip element for discharging extruded material from a gap, the flow cross section of which can be modified, wherein at least one flexible lip element can be moved relative to the other lip element by means of a plurality of jointly actuatable lever elements.

2. The extrusion die according to claim 1, wherein the flexible lip element has a tapered flexural region between an exit region and a die body, the plurality of jointly actuatable lever elements being situated between the exit region and the die body.

3. The extrusion die according to claim 1, wherein on one end the plurality of lever elements is mounted in a groove in the exit region, and on the other end pivotably engages with a slide in the die body or a retaining element associated therewith, the slide being supported with respect to the die body and/or the retaining element.

4. The extrusion die according to claim 3, wherein the slide can be moved back and forth linearly in an X direction.

5. The extrusion die according to claim 3, wherein the slide can be moved back and forth in an X direction by means of an actuating element.

6. The extrusion die according to claim 5, wherein the actuating element is designed as a manually actuatable drive device, in particular a screw thread or spindle.

7. The extrusion die according to claim 5, wherein the actuating element is designed as a geared element, servomotor, electromechanical drive device, hydraulic cylinder, or the like.

8. The extrusion die according to claim 3, wherein the slide is mounted in a recess in the die body or a retaining element thereof.

9. The extrusion die according to claim 8, wherein the slide in the recess is supported by a plurality of needle roller bearing elements.

10. The extrusion die according to claim 3, wherein the slide can be linearly moved, and under pushing or pulling loads is supported by a plurality of bearing elements.

11. The extrusion die according to claim 4, wherein a gap height of the flow cross section between the respective oppositely situated lip elements may be modified by a linear motion of the slide in the X direction as the result of pivoting of the lever elements about an angle.

12. The extrusion die according to claim 4, wherein a plurality of lever elements adjacently situated in parallel are pivotably mounted at one end in the flexible lip element, and at the other end are mounted in the slide at a uniform distance from one another, the slide element being supported and mounted so as to be linearly movable in the X direction with respect to the die body or a retaining element.

13. The extrusion die according to claim 1, wherein the other flexible lip element has a plurality of actuators running over the entire width in order to adjust the flexible lip element between an exit region, a tapered region, and a die body over the width as a function of the location, for setting a parallel, uniform gap.
